(19) United States
(12) Patent Application Publication
(10) Pub. No.: US 2019/0178196 A1
(43) Pub. Date: Jun. 13, 2019

(54) CONTROL DEVICE FOR FUEL PUMP

(71) Applicant: TOYOTA JIDOSHA KABUSHIKI KAISHA, Toyota-shi (JP)

(72) Inventor: Seiji OKAMURA, Toyota-shi (JP)

(73) Assignee: TOYOTA JIDOSHA KABUSHIKI KAISHA, Toyota-shi (JP)

(21) Appl. No.: 16/204,673

(22) Filed: Nov. 29, 2018

(30) Foreign Application Priority Data
Dec. 13, 2017 (JP) 2017-238768

(51) Int. Cl. F02D 41/38; F02D 1/16; F02D 41/40

(52) U.S. Cl. CPC F02D 41/3845; F02D 2001/009; F02D 41/403; F02D 1/16

(57) ABSTRACT

A control device for a motor-driven fuel pump adapted for an internal combustion engine is provided. The internal combustion engine including a fuel injection valve configured to execute multistage injection in which fuel is injected into a cylinder multiple times in one combustion cycle. The fuel pump includes a cylinder, a mover in the cylinder, and an electric actuator configured to move the mover. The control device is configured to cause the fuel pump to discharge fuel in a period between an end of a multistage injection from the fuel injection valve and a start of a next multistage injection, and keep the fuel pump from discharging fuel in a period during which the multistage injection from the fuel injection valve is executed.

### BACKGROUND

The present disclosure relates to a control device for a fuel pump.

An internal combustion engine disclosed in Japanese Laid-Open Patent Publication No. 2002-242786 includes a fuel injection valve for injecting fuel into a cylinder, a fuel pipe connected to the fuel injection valve, and a fuel pump for supplying the fuel to the fuel pipe. The fuel pump includes a pump housing having a pump chamber with which a fuel suction port and a fuel discharge port communicate, and a driving member for increasing and reducing the volume of the pump chamber by being displaced. The fuel pump includes a spring for biasing the driving member in a direction of reducing the volume of the pump chamber. The fuel pump also includes an electromagnetic actuator for displacing the driving member in a direction of increasing the volume of the pump chamber against the biasing force of the spring. The fuel pump displaces the driving member by the action of the spring and the electromagnetic actuator to execute a suction operation for drawing in fuel into the pump chamber, and a discharge operation for pressurizing the fuel drawn into the pump chamber and thus discharging the fuel from the pump chamber.

In a control device for the fuel pump disclosed in the above-described publication, immediately after the fuel injection from the fuel injection valve is completed, the fuel pump is driven to perform fuel discharge. Thus, the fluctuations of the fuel pressure in the fuel pipe due to the fuel discharge from the fuel pump converge before the next fuel injection is started.

When fuel injection is performed, there are cases where multistage injection is performed, in which fuel is injected multiple times in one combustion cycle. However, the above-described publication discloses no control of the fuel pump to execute such a multistage injection. In view of this, an object of the present disclosure is to appropriately drive a fuel pump for supplying fuel to a fuel injection valve configured to execute multistage injection.

### SUMMARY

In accordance with a first aspect of the present disclosure, a control device for a fuel pump is provided. The fuel pump is a motor-driven fuel pump adapted for an internal combustion engine. The internal combustion engine includes a fuel injection valve configured to execute multistage injection in which fuel is injected into a cylinder multiple times in one combustion cycle. The fuel pump is configured to supply fuel to a fuel pipe connected to the fuel injection valve. The fuel pump includes a cylinder, a mover configured to slide in the cylinder, and an electric actuator configured to move the mover. The control device comprises processing circuitry that is configured to: perform energization control on the electric actuator to reciprocate the mover so that the fuel pump draws in fuel and discharges fuel; and cause the fuel pump to discharge fuel in a period between an end of a multistage injection from the fuel injection valve and a start of a next multistage injection, and keep the fuel pump from discharging fuel in a period during which the multistage injection from the fuel injection valve is executed.

In accordance with a second aspect of the present disclosure, a control device for a fuel pump is provided. The fuel pump is a motor-driven fuel pump adapted for an internal combustion engine. The internal combustion engine includes a fuel injection valve configured to execute multistage injection in which fuel is injected into a cylinder multiple times in one combustion cycle. The multistage injection includes main injection in which the largest amount of fuel is injected and sub-injection in which a smaller amount of fuel than the amount in the main injection is injected. The fuel pump is configured to supply fuel to a fuel pipe connected to the fuel injection valve. The fuel pump includes a cylinder, a mover configured to slide in the cylinder, and an electric actuator configured to move the mover. The control device comprises processing circuitry that is configured to: perform energization control on the electric actuator to reciprocate the mover so that the fuel pump draws in and discharges fuel; and cause the fuel pump to start fuel discharge and end the fuel discharge in a period between a start or an end of the main injection and a start of a next main injection.

In accordance with a third aspect of the present disclosure, a control device for a fuel pump is provided. The fuel pump is a motor-driven fuel pump adapted for an internal combustion engine. The internal combustion engine includes a fuel injection valve configured to execute multistage injection in which fuel is injected into a cylinder multiple times in one combustion cycle. The multistage injection includes main injection in which the largest amount of fuel is injected and sub-injection in which a smaller amount of fuel than the amount in the main injection is injected. The fuel pump is configured to supply fuel to a fuel pipe connected to the fuel injection valve. The fuel pump includes a cylinder, a mover configured to slide in the cylinder, and an electric actuator configured to move the mover. The control device comprises processing circuitry that is configured to: perform energization control on the electric actuator to reciprocate the mover so that the fuel pump draws in and discharges fuel; execute a first discharge control, in which, when an injection interval between an end timing of the multistage injection from the fuel injection valve and a start timing of the next multistage injection is equal to or larger than a determination value, the processing circuitry causes the fuel pump to start fuel discharge in a period between an end of the multistage injection and a start of the next multistage injection, and keep the fuel pump from executing fuel discharge in a period during which the multistage injection from the fuel injection valve is executed; and execute a second discharge control, in which, when the injection interval is less than the determination value, the processing circuitry causes the fuel pump to start fuel discharge in a period between an end of the main injection and a start of the sub-injection that is executed after the main injection.

Other aspects and advantages of the present disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the presently preferred embodiments together with the accompanying drawings in which:

FIG. 1 is a schematic diagram showing a configuration of an internal combustion engine including a control device for a fuel pump according to a first embodiment;

FIG. 2 is a cross-sectional view of the high-pressure fuel pump in FIG. 1;

FIG. 3 is a cross-sectional view showing a state during fuel discharge in the high-pressure fuel pump in FIG. 2;

FIG. 4 is a cross-sectional view showing a state during fuel suction in the high-pressure fuel pump in FIG. 2;

FIG. 5 is a functional block diagram of the control device in FIG. 1;

FIG. 6 is a timing diagram showing an example of a manner of fuel injection from the fuel injection valve and a manner of fuel discharge from the high-pressure fuel pump;

FIG. 7 is a timing diagram showing an example of a manner of fuel injection from a fuel injection valve and a manner of fuel discharge from the high-pressure fuel pump according to a second embodiment;

FIG. 8 is a functional block diagram of a discharge start timing calculation section according to a third embodiment; and

FIG. 9 is a timing diagram showing an example of a manner of fuel injection from the fuel injection valve and a manner of fuel discharge from the high-pressure fuel pump according to the third embodiment.

### DETAILED DESCRIPTION

### First Embodiment

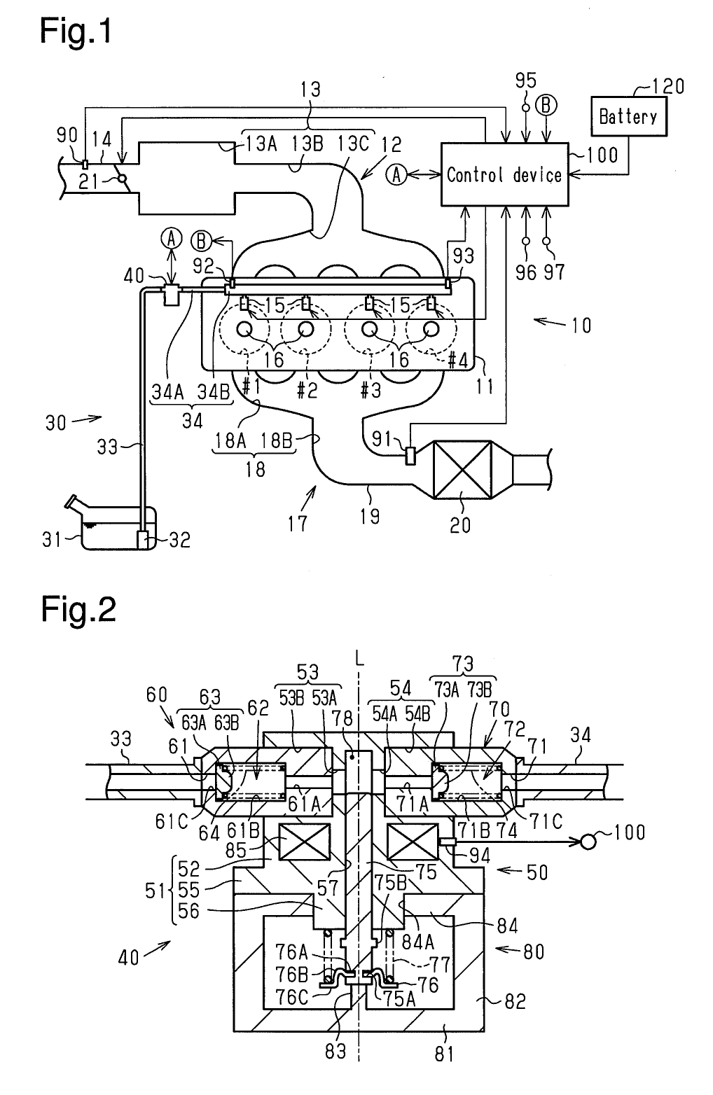

A control device for a fuel pump according to a first embodiment will now be described with reference to FIGS. 1 to 6.

As shown in FIG. 1, an engine main body 11 of an internal combustion engine 10 mounted on a vehicle includes four cylinders (a first cylinder #1 to a fourth cylinder #4). To the engine main body 11, an intake passage 12 is connected. The intake passage 12 includes an intake manifold 13 and an intake pipe 14 connected to the end of the intake manifold 13 on the intake upstream side. The intake manifold 13 includes a surge tank 13A connected to the intake pipe 14, an intake introduction section 13B provided on the intake downstream side of the surge tank 13A, and an intake branching section 13C provided on the intake downstream side of the intake introduction section 13B. The surge tank 13A has a larger passage cross-sectional area than the intake pipe 14 and the intake introduction section 13B. The intake branching section 13C has four end portions branching on the intake downstream side, and the respective four branching end portions are connected to different cylinders. The intake pipe 14 is provided with a throttle valve 21. By controlling the opening degree of the throttle valve 21, the flow rate of the intake air flowing through the intake passage 12 is controlled. The air flowing from the intake pipe 14 to the intake manifold 13 is supplied to the respective cylinders #1 to #4. The intake pipe 14 is provided with an air flow meter 90 that detects the flow rate of the intake air flowing through the intake passage 12 on the intake upstream side with respect to the throttle valve 21.

The engine main body 11 is provided with a plurality of fuel injection valves 15. One fuel injection valve 15 is provided for each cylinder. The fuel injection valve 15 is disposed in the cylinder to inject fuel into the cylinder. In each of the cylinders #1 to #4, an ignition plug 16 is provided. In each of the cylinders #1 to #4, the intake air introduced through the intake passage 12 and the fuel injected from the fuel injection valve 15 are mixed to generate an air-fuel mixture. The mass ratio of intake air to fuel in the air-fuel mixture is referred to as air-fuel ratio. The air-fuel mixture is ignited by the ignition plug 16 and combusted.

To the engine main body 11, an exhaust passage 17 is connected. The exhaust passage 17 includes an exhaust manifold 18 and an exhaust pipe 19 connected to the end of the exhaust manifold 18 on the exhaust downstream side. The exhaust manifold 18 is composed of an exhaust branching section 18A connected to the engine main body 11 and an exhaust confluence section 18B provided on the exhaust downstream side of the exhaust branching section 18A. The exhaust branching section 18A has four branched ends on the exhaust upstream side, and the respective four branching end portions are connected to different cylinders. In each of the cylinders #1 to #4, exhaust gas generated by combustion of the air-fuel mixture is discharged to the exhaust manifold 18. In the exhaust passage 17, a catalyst 20 disposed in the exhaust pipe 19 to purify the exhaust gas is provided. Further, in the exhaust pipe 19, an air-fuel ratio sensor 91 is disposed on the exhaust upstream side of the catalyst 20. The air-fuel ratio sensor 91 outputs an electric signal corresponding to the oxygen concentration of the exhaust gas flowing through the exhaust passage 17, that is, the air-fuel ratio of the air-fuel mixture used for combustion.

The internal combustion engine 10 is provided with a fuel supply device 30 for supplying fuel to the fuel injection valve 15 provided in the engine main body 11. The fuel supply device 30 includes a fuel tank 31 in which fuel is stored. Inside the fuel tank 31, a low-pressure fuel pump 32 is disposed. To the low-pressure fuel pump 32, one end of a low-pressure fuel pipe 33 is connected. The low-pressure fuel pump 32 is a motor-driven fuel pump, pumps up the fuel in the fuel tank 31, and discharges the fuel to the low-pressure fuel pipe 33. To the other end of the low-pressure fuel pipe 33, a high-pressure fuel pump 40 is connected. To the high-pressure fuel pump 40, a high-pressure fuel pipe 34 is connected. The high-pressure fuel pipe 34 is composed of a discharge pipe 34A connected to the high-pressure fuel pump 40 and a delivery pipe 34B connected to the discharge pipe 34A. To the delivery pipe 34B, the respective fuel injection valves 15 are connected. The fuel discharged from the low-pressure fuel pump 32 to the low-pressure fuel pipe 33 is drawn into the high-pressure fuel pump 40. In the high-pressure fuel pump 40, the drawn fuel is pressurized and discharged to the discharge pipe 34A. The fuel discharged to the discharge pipe 34A is supplied to the delivery pipe 34B and injected into the cylinder from the fuel injection valve 15. In the delivery pipe 34B, a pressure sensor 92 is provided on a first end portion connected to the discharge pipe 34A. The pressure sensor 92 detects the fuel pressure Pr in the high-pressure fuel pipe 34. In the delivery pipe 34B, a fuel temperature sensor 93 is provided on a second end portion opposite to the first end portion. The fuel temperature sensor 93 detects the temperature of the fuel in the high-pressure fuel pipe 34.

As shown in FIG. 2, the high-pressure fuel pump 40 includes a pump section 50 that draws in and pressurizes fuel and a casing 80 to which the pump section 50 is connected.

The casing 80 has a box shape. The casing 80 has a lower wall 81 and an upper wall 84 that each have a disc shape, and a peripheral side wall 82 that extends from the circumferential edge of the lower wall 81 to the circumferential edge of the upper wall 84. At a central portion of the lower wall 81, a columnar protruded portion 83 that protrudes in the inner space side of the casing 80 is provided. The peripheral side wall 82 is continuously provided over the entire periphery of the circumferential edge of the lower wall 81 and the upper wall 84, and has a cylindrical shape. The upper wall 84 has a through hole 84A at a central portion.

The pump section 50 includes a housing 51 fixed to the upper end surface of the upper wall 84. The housing 51 is composed of a main body portion 52 having a cylindrical shape, a flange portion 55 disposed between the main body portion 52 and the upper wall 84, and an insertion portion 56 extending from the flange portion 55. The flange portion 55 has a larger diameter than the main body portion 52 and is in contact with the upper wall 84. The insertion portion 56 extends from the flange portion 55 to the inner space of the casing 80 through the through hole 84A. The outer diameter of the insertion portion 56 is the same as the inner diameter of the through hole 84A. Therefore, the outer circumferential surface of the insertion portion 56 is in contact with the inner circumferential surface of the through hole 84A of the upper wall 84. The housing 51 has a cylinder bore 57. The cylinder bore 57 extends from one end face (the lower end face in FIG. 2) of the insertion portion 56 to the inside of the main body portion 52. Hereinafter, the extending direction (the up-down direction in FIG. 2) of the central axis L of the cylinder bore 57 is simply referred to as the axial direction.

The main body portion 52 has a first orthogonal hole 53 and a second orthogonal hole 54 that extend in a direction (the left-right direction in FIG. 2) orthogonal to the axial direction and communicate with the cylinder bore 57. The first orthogonal hole 53 and the second orthogonal hole 54 extend in opposite directions from the cylinder bore 57. The first orthogonal hole 53 has a first small diameter portion 53A that communicates with the cylinder bore 57 and a first large diameter portion 53B that extends from the first small diameter portion 53A to the side peripheral surface of the main body portion 52 and opens on the side peripheral surface. In the first large diameter portion 53B, a suction valve 60 is inserted and fitted.

The suction valve 60 has a cylindrical shape and is attached to the main body portion 52 in a state of protruding from the main body portion 52. In the suction valve 60, a suction passage 61 extends through the suction valve 60 in the above-described orthogonal direction is formed. The suction passage 61 is composed of a first suction passage 61A that is connected to the first small diameter portion 53A, a second suction passage 61B that is connected to the first suction passage 61A and has a larger diameter than the first suction passage 61A, and a third suction passage 61C that is connected to the second suction passage 61B and has the same diameter as the first suction passage 61A. In the second suction passage 61B, a first check valve 62 is disposed. The first check valve 62 is composed of a first valve body 63 and a first spring 64 for biasing the first valve body 63 toward the third suction passage 61C. The first valve body 63 is composed of a first biasing portion 63A that is in contact with the inner end surface of the second suction passage 61B on which the third suction passage 61C opens, and a first bulging portion 63B that bulges from the central portion of the first biasing portion 63A toward the first suction passage 61A. The first bulging portion 63B has a hemispherical shape. The first spring 64 has a first end that is in contact with the inner end surface of the second suction passage 61B on which the first suction passage 61A opens, and a second end that is in contact with the first biasing portion 63A of the first valve body 63. To the suction valve 60, the low-pressure fuel pipe 33 is connected, and to the third suction passage 61C, fuel is supplied from the low-pressure fuel pipe 33.

The second orthogonal hole 54 has a second small diameter portion 54A that communicates with the cylinder bore 57 and a second large diameter portion 54B that extends from the second small diameter portion 54A to the side peripheral surface of the main body portion 52 and opens on the side peripheral surface. In the second large diameter portion 54B, a discharge valve 70 is inserted and fitted. The discharge valve 70 has a cylindrical shape and is attached to the main body portion 52 in a state of protruding from the main body portion 52. The discharge valve 70 and the suction valve 60 are arranged side by side on the same axis extending in the above-described orthogonal direction. In the discharge valve 70, a discharge passage 71 extending through the discharge valve 70 in the above-described orthogonal direction is formed. The discharge passage 71 is composed of a first discharge passage 71A that is connected to the second small diameter portion 54A, a second discharge passage 71B that is connected to the first discharge passage 71A and has a larger diameter than the first discharge passage 71A, and a third discharge passage 71C that is connected to the second discharge passage 71B and has the same diameter as the first discharge passage 71A. In the second discharge passage 71B, a second check valve 72 is disposed.

The second check valve 72 is composed of a second valve body 73 and a second spring 74 for biasing the second valve body 73 toward the first discharge passage 71A. The second valve body 73 is composed of a second biasing portion 73A that is in contact with the inner end surface of the second discharge passage 71B on which the first discharge passage 71A opens, and a second bulging portion 73B that bulges from the central portion of the second biasing portion 73A toward the third discharge passage 71C. The second bulging portion 73B has a hemispherical shape. The second spring 74 has a first end that is in contact with the inner end surface of the second discharge passage 71B on which the third discharge passage 71C opens, and a second end that is in contact with the second biasing portion 73A of the second valve body 73. To the discharge valve 70, the high-pressure fuel pipe 34 is connected.

The pump section 50 includes a plunger 75 serving as a mover that is inserted into the cylinder bore 57 and that is slidable in the cylinder bore 57. The plunger 75 is made of a magnetic material. The plunger 75 has a columnar rod shape and is inserted into the cylinder bore 57 from the lower end opening of the insertion portion 56. The lower end portion of the plunger 75 extends from the cylinder bore 57 to the inner space of the casing 80. The plunger 75 has a groove 75A at a lower end portion. The groove 75A extends over the entire circumference in the circumferential direction. Therefore, the plunger 75 has a diameter that is partially reduced at the position in which the groove 75A is formed. To the groove 75A, a pedestal 76 having an annular plate shape is connected. The pedestal 76 is composed of a central portion 76A engaged with the groove 75A, a curved portion 76B having a curve and extending outward in the radial direction from the central portion 76A, and a flat portion 76C extending outward in the radial direction from the curved portion 76B. Between the flat portion 76C and the insertion portion 56 of the housing 51, a compression spring 77 is disposed. The compression spring 77 biases the pedestal 76 in a direction away from the housing 51, that is, in a direction of pulling out the plunger 75 from the cylinder bore 57 (downward in FIG. 2). The lower end surface of the plunger 75 is pressed against the upper end surface of the protruded portion 83 of the casing 80 by the biasing force of the compression spring 77. The plunger 75 has a protrusion 75B at a lower end portion above the groove 75A. The protrusion 75B extends over the entire circumference in the circumferential direction. Therefore, the plunger 75 has a diameter that is partially increased at the position of the protrusion 75B. The diameter of the protrusion 75B is larger than the diameter of the cylinder bore 57. The cylinder bore 57, the plunger 75, the first small diameter portion 53A, the first suction passage 61A, the second suction passage 61B, the second small diameter portion 54A, and the first discharge passage 71A constitute a pressurizing chamber 78 of the pump section 50.

In the main body portion 52 of the housing 51, a coil 85 is disposed so as to surround the periphery of the cylinder bore 57. The coil 85 generates a magnetic field upon energization. When the coil 85 is energized, the plunger 75 is excited by the magnetic field generated around the coil 85.

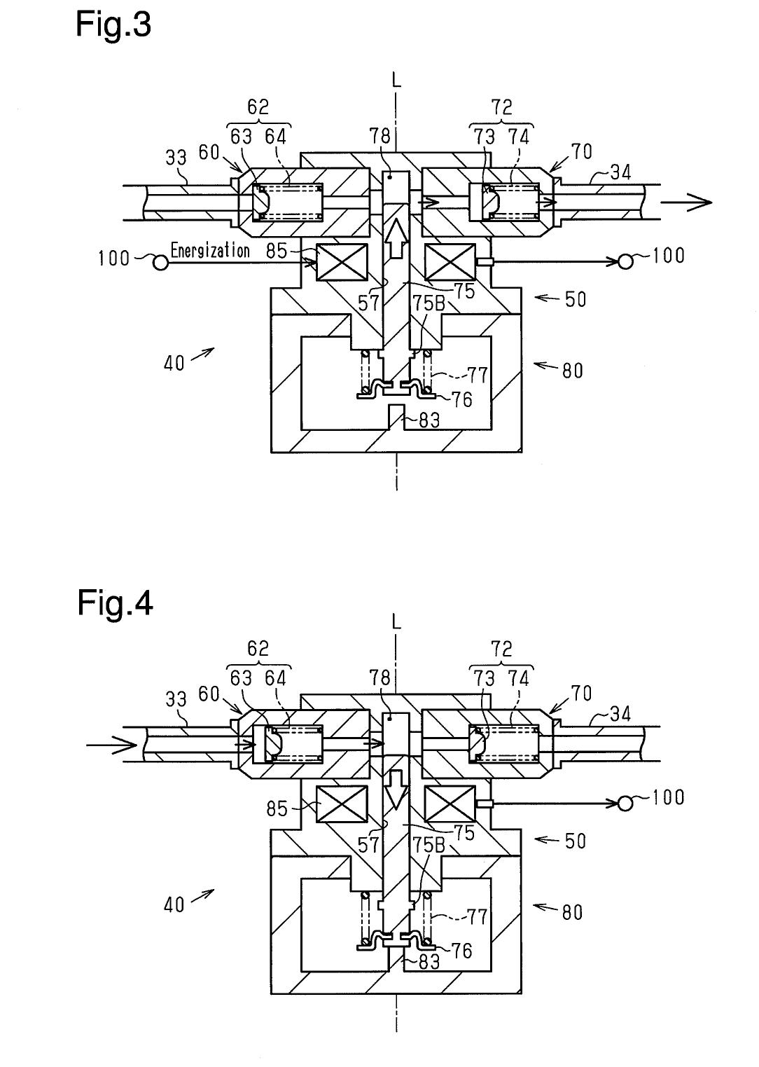

As indicated by the blank arrow in FIG. 3, when the plunger 75 is excited, the plunger 75 moves to a first side (the upper side in FIG. 3) in the axial direction against the biasing force of the compression spring 77. The plunger 75 moves to the first side until the protrusion 75B comes into contact with the insertion portion 56. This movement of the plunger 75 decreases the volume of the pressurizing chamber 78 of the pump section 50 and increases the pressure in the pressurizing chamber 78. Since the pressurizing chamber 78 is filled with fuel as described later, increasing the pressure of the pressurizing chamber 78 makes the discharge valve 70 open. Specifically, the second valve body 73 of the discharge valve 70 is subjected to the pressure in the pressurizing chamber 78 in the valve opening direction, and is also subjected to the pressure in the high-pressure fuel pipe 34 and the biasing force of the second spring 74 in the valve closing direction. When the pressure in the pressurizing chamber 78 increases and the force of biasing the second valve body 73 in the valve opening direction becomes higher than the force of biasing the second valve body 73 in the valve closing direction, the second valve body 73 is opened. When the second valve body 73 opens, fuel is discharged from the pressurizing chamber 78 to the high-pressure fuel pipe 34 as indicated by the solid line arrow in FIG. 3. While the fuel is discharged from the high-pressure fuel pump 40 to the high-pressure fuel pipe 34, the suction valve 60 is held in a closed state by the pressure in the pressurizing chamber 78. On the other hand, when the energization to the coil 85 is stopped, the excitation of the plunger 75 is cancelled.

As indicated by the blank arrow in FIG. 4, when the excitation of the plunger 75 is cancelled, the plunger 75 moves to a second side (the lower side in FIG. 4) in the axial direction by the biasing force of the compression spring 77 so that the plunger 75 is pulled out from the cylinder bore 57. The plunger 75 moves to the second side until its lower end comes into contact with the protruded portion 83. This movement of the plunger 75 increases the volume of the pressurizing chamber 78 and decreases the pressure in the pressurizing chamber 78. The first valve body 63 of the suction valve 60 is subjected to the pressure in the low-pressure fuel pipe 33 in the valve opening direction, and is also subjected to the pressure in the pressurizing chamber 78 and the biasing force of the first spring 64 in the valve closing direction. When the pressure in the pressurizing chamber 78 decreases and the force of biasing the first valve body 63 in the valve closing direction becomes lower than the force of biasing the first valve body 63 in the valve opening direction, the first valve body 63 is opened. When the first valve body 63 opens, fuel is supplied from the low-pressure fuel pipe 33 to the pressurizing chamber 78 as indicated by the solid line arrow in FIG. 4. While the high-pressure fuel pump 40 draws in the fuel from the low-pressure fuel pipe 33, the discharge valve 70 is held in a closed state by the pressure in the high-pressure fuel pipe 34.

In this manner, the plunger 75 reciprocates in the axial direction inside the cylinder bore 57 depending on the energization state of the coil 85. Accordingly, the coil 85 corresponds to an electric actuator for moving the plunger 75. Each time the plunger 75 reciprocates, the high-pressure fuel pump 40 performs a suction function of drawing in the fuel and a discharge function of pressurizing and discharging the drawn fuel. Further, in the main body portion 52 of the fuel pump, a coil temperature sensor 94 is provided. The coil temperature sensor 94 detects the temperature of the coil 85.

As shown in FIG. 1, the fuel supply device 30 includes a control device 100 for a fuel pump. Further, the internal combustion engine 10 includes a battery 120. The battery 120 supplies electric power to the respective parts of the internal combustion engine 10, such as the control device 100 and the electric actuator of the high-pressure fuel pump 40.

To the control device 100, output signals are input from the air flow meter 90, the air-fuel ratio sensor 91, the pressure sensor 92, the fuel temperature sensor 93, and the coil temperature sensor 94. To the control device 100, an output signal of a crank angle sensor 95 that detects the engine rotational speed NE, which is a rotational speed of a crankshaft of the internal combustion engine 10, and the crank angle CA, which is a rotation phase of the crankshaft is also input. Further, to the control device 100, output signals from various sensors such as an accelerator sensor 96 for detecting an accelerator operation amount Acc that is an operation amount of an accelerator pedal, a vehicle speed sensor 97 for detecting a vehicle speed V, etc., are also input. The control device 100 includes a CPU, a ROM, and a RAM. The control device 100 causes the CPU to execute programs stored in the ROM to control driving of the fuel injection valve 15, and driving of the high-pressure fuel pump 40.

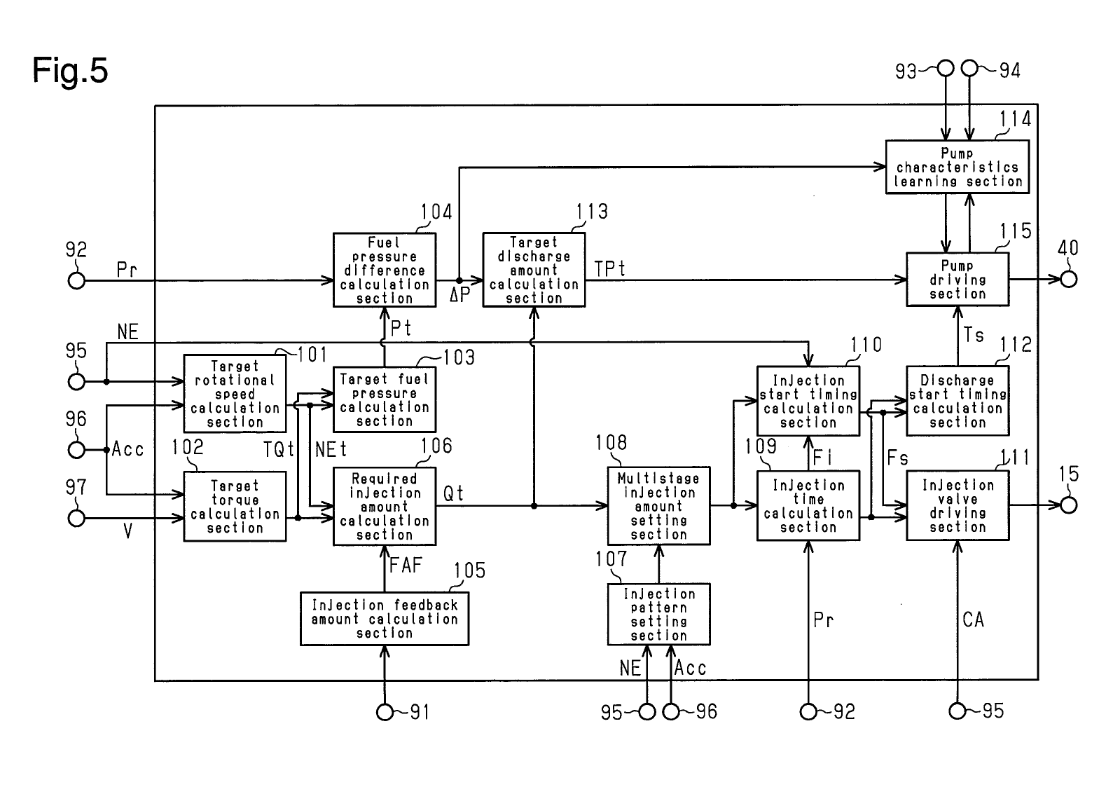

As shown in FIG. 5, the control device 100 includes a target rotational speed calculation section 101, a target torque calculation section 102, a target fuel pressure calculation section 103, a fuel pressure difference calculation section 104, an injection feedback amount calculation section 105, and a required injection amount calculation section 106. The control device 100 also includes an injection pattern setting section 107, a multistage injection amount setting section 108, an injection time calculation section 109, an injection start timing calculation section 110, and an injection valve driving section 111. Furthermore, the control device 100 includes a discharge start timing calculation section 112, a target discharge amount calculation section 113, a pump characteristics learning section 114, and a pump driving section 115.

The target rotational speed calculation section 101 calculates a target rotational speed NEt that is a target value of the engine rotational speed NE, based on the engine rotational speed NE detected by the crank angle sensor 95 and the accelerator operation amount Acc detected by the accelerator sensor 96.

The target torque calculation section 102 calculates a target torque TQt that is a target value of the axial torque of the crankshaft of the internal combustion engine 10, based on the vehicle speed V detected by the vehicle speed sensor 97 and the accelerator operation amount Acc detected by the accelerator sensor 96.

The target fuel pressure calculation section 103 calculates a target fuel pressure Pt that is a target value of the fuel pressure in the high-pressure fuel pipe 34, based on the target rotational speed NEt calculated by the target rotational speed calculation section 101 and the target torque TQt calculated by the target torque calculation section 102. In the target fuel pressure calculation section 103, a map indicating a relationship between a target fuel pressure Pt and each of a target rotational speed NEt and a target torque TQt is stored. This map is previously obtained by experiment and simulation. The target fuel pressure Pt is calculated so as to be higher when the target rotational speed NEt is high than when the target rotational speed NEt is low. Further, the target fuel pressure Pt is calculated so as to be higher when the target torque TQt is large than when the target torque TQt is small.

The fuel pressure difference calculation section 104 calculates a fuel pressure difference ΔP (ΔP=Pt−Pr), which is a value obtained by subtracting the fuel pressure Pr in the high-pressure fuel pipe 34 detected by the pressure sensor 92 from the target fuel pressure Pt calculated by the target fuel pressure calculation section 103.

The injection feedback amount calculation section 105 calculates an injection feedback amount FAF for feedback control of feeding the actual air-fuel ratio detected by the air-fuel ratio sensor 91 back to the target air-fuel ratio that is a target value of the air-fuel ratio. The target air-fuel ratio is calculated based on the operating state of the internal combustion engine 10 by the control device 100. The injection feedback amount calculation section 105 inputs a value obtained by subtracting the actual air-fuel ratio from the target air-fuel ratio to a proportional element, an integral element, and a differential element, and outputs as an injection feedback amount FAF the sum of an output value of the proportional element, an output value of the integral element, and an output value of the differential element.

The required injection amount calculation section 106 calculates a required fuel injection amount Qt that is a target value of the fuel amount injected from each fuel injection valve 15. The required injection amount calculation section 106 calculates a base injection amount Qb based on the target rotational speed NEt calculated by the target rotational speed calculation section 101 and the target torque TQt calculated by the target torque calculation section 102. The base injection amount Qb is calculated so as to be larger when the target rotational speed NEt is high than when the target rotational speed NEt is low. Further, the base injection amount Qb is calculated so as to be larger when the target torque TQt is large than when the target torque TQt is small. The base injection amount Qb is calculated as a fuel injection amount corresponding to the target air-fuel ratio. The required injection amount calculation section 106 calculates the required fuel injection amount Qt by multiplying the base injection amount Qb by the injection feedback amount FAF calculated by the injection feedback amount calculation section 105.

The injection pattern setting section 107 sets an injection pattern for multistage injection based on the engine rotational speed NE detected by the crank angle sensor 95 and the accelerator operation amount Acc detected by the accelerator sensor 96. In the multistage injection, fuel is injected multiple times in one combustion cycle. The injection pattern for multistage injection includes main injection and sub-injection to be executed during a different period from the main injection. The sub-injection includes pilot-injection and pre-injection, in which fuel is injected before the main injection, and after-injection and post-injection, in which fuel is injected after the main injection. In the main injection, the largest amount of fuel is injected, which contributes most to combustion accordingly. The injection pattern is previously obtained by experiment and simulation so as to be most suitable for the operating state of the internal combustion engine 10 based on the engine rotational speed NE and the accelerator operation amount Acc, and stored in the injection pattern setting section 107.

The multistage injection amount setting section 108 calculates a target injection amount of each injection in the multistage injection, based on the injection pattern set by the injection pattern setting section 107 and the required fuel injection amount Qt calculated by the required injection amount calculation section 106. For example, when the injection pattern set by the injection pattern setting section 107 includes the pre-injection, the main injection, and the after-injection, the multistage injection amount setting section 108 first sets as a target injection amount Qtm for the main injection an injection amount obtained by multiplying the required fuel injection amount Qt by a predetermined main ratio (for example, 90%). The main ratio is set such that the target injection amount Qtm for the main injection is maximized in one combustion cycle. The pre-injection is performed to suppress the ignition delay of fuel in the main injection so as to make combustion stable. A target injection amount Qtp for the pre-injection is calculated by multiplying the required fuel injection amount Qt by a pre-ratio (<100%−the main ratio) calculated depending on the temperature in each cylinder. The main ratio and the pre-ratio are previously obtained by experiment and simulation, etc., and are stored in the control device 100. After calculating the target injection amount Qtm for the main injection and the target injection amount Qtp for the pre-injection in this way, the multistage injection amount setting section 108 subtracts an injection amount obtained by adding the target injection amount Qtm and the target injection amount Qtp from the required fuel injection amount Qt thus to calculate a target injection amount Qta (Qta=Qt−(Qtm+Qtp)) for the after-injection. The target injection amount Qtp for the pre-injection and the target injection amount Qta for the after-injection are each smaller than the target injection amount Qtm for the main injection.

The injection time calculation section 109 calculates an injection time Fi as the execution time of each injection in the injection pattern set by the injection pattern setting section 107, based on each target injection amount set by the multistage injection amount setting section 108 and the fuel pressure Pr detected by the pressure sensor 92. For example, when the injection pattern includes the pre-injection, the main injection, and the after-injection, an injection time Fip of the pre-injection is calculated based on the target injection amount Qtp for the pre-injection and the fuel pressure Pr. Further, an injection time Fim of the main injection is calculated based on the target injection amount Qtm for the main injection and the fuel pressure Pr. In addition, an injection time Fia of the after-injection is calculated based on the target injection amount Qta for the after-injection and the fuel pressure Pr.

The injection start timing calculation section 110 calculates an injection start timing Fs of each injection in the injection pattern set by the injection pattern setting section 107. The injection start timing Fs of each injection is calculated based on each target injection amount set by the multistage injection amount setting section 108, each injection time calculated by the injection time calculation section 109, the engine rotational speed NE detected by the crank angle sensor 95. For example, when the injection pattern includes the pre-injection, the main injection, and the after-injection, the injection start timing calculation section 110 calculates an injection start timing Fsp of the pre-injection, an injection start timing Fsm of the main injection, and an injection start timing Fsa of the after-injection.

The injection valve driving section 111 drives the fuel injection valve 15 to execute multistage injection in which fuel is injected multiple times in one combustion cycle. Then, at the injection start timing Fs calculated by the injection start timing calculation section 110, the injection valve driving section 111 controls driving of the fuel injection valve 15 based on the crank angle CA detected by the crank angle sensor 95 so that fuel injection from the fuel injection valve 15 is started. After the fuel injection is continued during the injection time Fi calculated by the injection time calculation section 109 from the start of the fuel injection, the injection valve driving section 111 ends the fuel injection from the fuel injection valve 15.

The discharge start timing calculation section 112 calculates a discharge start timing Ts that is a point in time at which fuel discharge from the high-pressure fuel pump 40 to the high-pressure fuel pipe 34 is started. The discharge start timing Ts is calculated based on the timing of fuel injection of the fuel injection valve 15. In the present embodiment, the discharge start timing Ts is set to the timing at which a predetermined preparation time has elapsed from the end timing Fe of fuel injection of the fuel injection valve 15. The end timing Fe at which the multistage injection is ended is the end timing of the last injection in the injection pattern set by the injection pattern setting section 107. The end timing Fe of the multistage injection can be calculated based on the injection time Fi of the last injection and the injection start timing Fs of the last injection. The preparation time is set to a time required for the fuel pressure difference ΔP to become stable after the multistage injection from the fuel injection valve 15 is ended. The preparation time is previously obtained by experiment and simulation and stored in the control device 100.

The target discharge amount calculation section 113 calculates a target discharge amount TPt that is a target value of the fuel discharge amount from the high-pressure fuel pump 40 to the high-pressure fuel pipe 34. The target discharge amount calculation section 113 calculates a base discharge amount TPb based on the required fuel injection amount Qt calculated by the required injection amount calculation section 106. The base discharge amount TPb is calculated as an amount equal to the required fuel injection amount Qt. That is, the base discharge amount TPb increases as the required fuel injection amount Qt increases. Further, the target discharge amount calculation section 113 calculates a discharge feedback amount TK based on the fuel pressure difference ΔP calculated by the fuel pressure difference calculation section 104. In the present embodiment, a value obtained by subtracting from the target fuel pressure Pt the actual fuel pressure Pr after fuel is discharged from the high-pressure fuel pump 40 so as to reach the target fuel pressure Pt is input to a proportional element, an integral element, and an differential element, and the sum of an output value of the proportional element, an output value of the integral element, and an output value of the differential element is calculated as the discharge feedback amount TK. The target discharge amount calculation section 113 calculates the target discharge amount TPt by multiplying the base discharge amount TPb by the discharge feedback amount TK.

The pump characteristics learning section 114 learns a relationship between an energization time to the high-pressure fuel pump 40 and an amount of fuel discharged from the high-pressure fuel pump 40 to the high-pressure fuel pipe 34 as pump characteristics. The fuel discharge amount from the high-pressure fuel pump 40 is affected by the fuel temperature in the high-pressure fuel pipe 34 detected by the fuel temperature sensor 93, the temperature of the coil 85 detected by the coil temperature sensor 94, the battery voltage, and the like. In other words, the viscosity of the fuel is higher when the fuel temperature is low than when the fuel temperature is high. Therefore, the resistance in fuel discharge is larger when the fuel temperature is low than when the fuel temperature is high. Further, the force to move the plunger 75 toward the pressurizing chamber 78 is weaker when the temperature of the coil 85 is high than when the temperature of the coil 85 is low. In addition, the force to move the plunger 75 toward the pressurizing chamber 78 is weaker when the battery voltage is low than when the battery voltage is high. Thus, as the fuel temperature is lower, the temperature of the coil 85 is higher, or the battery voltage is lower, the amount of fuel discharged from the high-pressure fuel pump 40 tends to be smaller. The battery voltage can be obtained from a charge/discharge state of the battery 120. The pump characteristics learning section 114 calculates a discharge amount for which the high-pressure fuel pump 40 is driven for the energization time set based on the target discharge amount TPt, based on the fuel pressure difference ΔP calculated by the fuel pressure difference calculation section 104, and stores the discharge amount together with information of the fuel temperature, the temperature of the coil 85, and the battery voltage.

The pump driving section 115 performs energization control of the high-pressure fuel pump 40 to the coil 85 at the discharge start timing Ts calculated by the discharge start timing calculation section 112. The pump driving section 115 causes the plunger 75 to reciprocate through the energization control, thereby causing the high-pressure fuel pump 40 to execute fuel suction and fuel discharge. The pump driving section 115 ends the energization when a lift time Ti has elapsed from the start of the energization control for the high-pressure fuel pump 40. The pump driving section 115 sets the lift time Ti such that an amount of fuel corresponding to the target discharge amount TPt is discharged, based on the pump characteristics learned by the pump characteristics learning section 114.

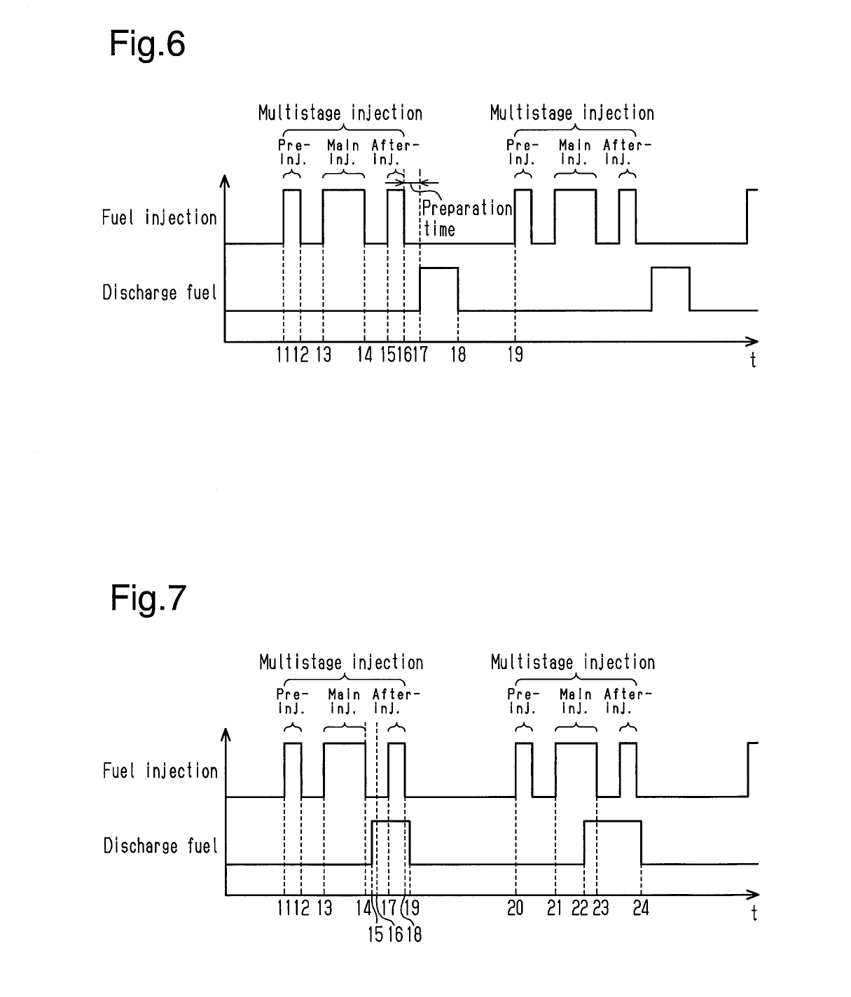

An operation and advantages of the present embodiment will now be described with reference to FIG. 6. In the following description, the point in time of each operation in FIG. 6 is indicated by t followed by three-digit numbers. However, in FIG. 6, the symbol t and the first digit 6 of the three digits are omitted.

In conjunction with the operation of the internal combustion engine 10, multistage injection is repeatedly executed. In an example shown in FIG. 6, the injection pattern for multistage injection includes the pre-injection, the main injection, and the after-injection. When the multistage injection is executed, the injection valve driving section 111 first starts fuel injection at a point in time t611 that is the injection start timing Fsp of the pre-injection calculated by the injection start timing calculation section 110. The injection valve driving section 111 continues the fuel injection during the injection time Fip of the pre-injection calculated by the injection time calculation section 109, and ends the pre-injection at a point in time t612 when the injection time Fip of the pre-injection has elapsed from the point in time t611. After that, the injection valve driving section 111 starts fuel injection at a point in time t613 that is the injection start timing Fsm of the main injection calculated by the injection start timing calculation section 110. The injection valve driving section 111 continues the fuel injection during the injection time Fim of the main injection calculated by the injection time calculation section 109, and ends the main injection at a point in time t614 when the injection time Fim of the main injection has elapsed from the point in time t613. After that, the injection valve driving section 111 starts fuel injection at a point in time t615 that is the injection start timing Fsa of the after-injection calculated by the injection start timing calculation section 110. The injection valve driving section 111 continues the fuel injection during the injection time Fia of the after-injection calculated by the injection time calculation section 109, and ends the main injection at a point in time t616 when the injection time Fia of the after-injection has elapsed from the point in time t615. In this way, the fuel injection valve 15 executes multistage injection.

After the multistage injection is executed, the target discharge amount calculation section 113 calculates a target discharge amount TPt at a point in time t617 when the preparation time described above has elapsed. The target discharge amount TPt is calculated based on a required fuel injection amount Qt for the next multistage injection calculated by the required injection amount calculation section 106 and a fuel pressure difference ΔP between the current fuel pressure Pr and the target fuel pressure Pt. The use of the fuel pressure difference ΔP when the preparation time has elapsed after the multistage injection is executed makes it possible to reduce the influence of the fluctuations of fuel pressure in the high-pressure fuel pipe 34 due to the execution of multistage injection. When the target discharge amount TPt is calculated at the point in time t617, the pump driving section 115 starts energization control to discharge an amount of fuel corresponding to the calculated target discharge amount TPt, and drives the high-pressure fuel pump 40. The fuel discharge is executed during the period between the point in time t617 and a point in time t618 when the lift time Ti has elapsed. Thus, the target discharge amount TPt of fuel is discharged from the high-pressure fuel pump 40 following the fuel injection.

Then, at a point in time t619 when a predetermined time has elapsed after the fuel discharge from the high-pressure fuel pump 40 is ended, the next multistage injection is executed. In this way, in the present embodiment, fuel is discharged during the period between the end of the multistage injection from the fuel injection valve and the start of the next multistage injection, while fuel is not discharged during the injection period in which the fuel injection is executed. Therefore, when the fuel injection is executed, the fluctuations of the fuel pressure Pr in the high-pressure fuel pipe 34 due to the fuel discharge from the high-pressure fuel pump 40 can be suppressed. Accordingly, fuel can be supplied to the high-pressure fuel pipe 34 at the timing that makes it possible to suppress the fluctuations of the fuel pressure Pr during the fuel injection period, and this provides appropriate driving of the high-pressure fuel pump 40.

### Second Embodiment

A control device for a fuel pump according to a second embodiment will be described with reference to FIG. 7. The second embodiment differs from the first embodiment in a manner in which the discharge start timing Ts is set in the discharge start timing calculation section 112. The same constituent elements as those in the first embodiment are denoted by the same reference numerals, and description thereof is omitted.

In the present embodiment, as in the first embodiment, a case where the injection pattern for multistage injection includes the pre-injection, the main injection, and the after-injection will be described as an example.

The discharge start timing calculation section 112 calculates a discharge start timing Ts as a point in time between an end timing Fem of the main injection and the injection start timing Fsa of the after-injection in the multistage injection. For example, the discharge start timing calculation section 112 calculates as the discharge start timing Ts a point in time closer to the end timing Fem of the main injection than the middle of both the timings Fem and Fsa in the period between the end timing Fem of the main injection and the injection start timing Fsa of the after-injection. The end timing Fem of the main injection can be calculated based on the injection time Fim of the main injection and an injection start timing Fsm of the main injection.

An operation and advantages of the present embodiment will now be described with reference to FIG. 7. In FIG. 7, regarding a symbol t indicating the point in time of each operation and three-digit numbers following the symbol, the symbol t and the first digit 7 of the three digits are omitted.

In conjunction with the operation of the internal combustion engine 10, multistage injection is repeatedly executed. When the multistage injection is executed, the injection valve driving section 111 first starts fuel injection at a point in time t711 that is the injection start timing Fsp of the pre-injection calculated by the injection start timing calculation section 110. The injection valve driving section 111 continues the fuel injection during the injection time Fip of the pre-injection calculated by the injection time calculation section 109, and ends the pre-injection at a point in time t712 when the injection time Fip has elapsed from the point in time t711. After that, the injection valve driving section 111 starts fuel injection at a point in time t713 that is the injection start timing Fsm of the main injection calculated by the injection start timing calculation section 110. The injection valve driving section 111 continues the fuel injection during the injection time Fim of the main injection calculated by the injection time calculation section 109, and ends the main injection at a point in time t714 when the injection time Fim has elapsed from the point in time t713.

In the present embodiment, the discharge start timing calculation section 112 calculates, as the discharge start timing Ts, a point in time between the end timing Fem of the main injection and the injection start timing Fsa of the after-injection. Accordingly, the pump driving section 115 starts driving of the high-pressure fuel pump 40 at a point in time t715 between when the main injection is ended at the point in time t714 and when the after-injection is started by the injection valve driving section 111. The discharge start timing Ts is the point in time t715 closer to the end timing Fem (point in time t714) of the main injection than a point in time t716 that is the middle of both the timings Fem and Fsa in the period between the end timing Fem (point in time t714) of the main injection and the injection start timing Fsa (point in time t717) of the after-injection. The target discharge amount calculation section 113 calculates a target discharge amount TPt at the discharge start timing Ts (point in time t715). The target discharge amount TPt is calculated based on a required fuel injection amount Qt for the next multistage injection calculated by the required injection amount calculation section 106 and a fuel pressure difference ΔP between the current fuel pressure Pr and the target fuel pressure Pt.

After energization control is executed at the point in time t715 to start fuel discharge, the pump driving section 115 performs fuel discharge until a point in time t719 when a lift time Ti calculated based on the target discharge amount TPt has elapsed. Thus, the target discharge amount TPt of fuel is discharged from the high-pressure fuel pump 40 to the high-pressure fuel pipe 34.

The injection valve driving section 111 starts fuel injection at the point in time t717 that is the injection start timing Fsa of the after-injection calculated by the injection start timing calculation section 110. The point in time t717 is later than the discharge start timing Ts (t715) of fuel discharge and is earlier than the end point in time t719 of fuel discharge. The injection valve driving section 111 continues the fuel injection during the injection time Fia of the after-injection calculated by the injection time calculation section 109, and ends the after-injection at a point in time t718 when the injection time Fia of the after-injection has elapsed from the point in time t717. The injection time Fia of the after-injection is shorter than the lift time Ti described above, and the after-injection is ended at the point in time (t718) earlier than the end point in time t718 of fuel discharge. Accordingly, the after-injection in multistage injection is executed within a period during which fuel is discharged from the high-pressure fuel pump 40. In addition, the fuel discharge is executed so as to overlap with only the injection period of the after-injection out of the main injection, the pre-injection, and the after-injection.

In this way, after the multistage injection from the fuel injection valve 15 and the fuel discharge from the high-pressure fuel pump 40 are ended, multistage injection is started from the next fuel injection valve at a point in time t720 when a predetermined time has elapsed.

In the present embodiment, the discharge of fuel is started and ended in the period from the end of the main injection in the multistage injection to the start of the main injection in the next multistage injection. In the main injection, fuel contributing most to combustion is injected. In this way, the fuel discharge from the high-pressure fuel pump 40 performed while avoiding the injection period of the main injection makes it possible to suppress the fluctuations of the fuel pressure Pr during execution of the main injection and thus to ensure a combustion quality. Therefore, fuel can be supplied to the high-pressure fuel pipe at the point in time that makes it possible to suppress the fluctuations of the fuel pressure Pr during the injection period of the main injection, and this provides appropriate driving of the high-pressure fuel pump.

In the present embodiment, fuel discharge is started in the period between the end of the main injection and the start of the after-injection, which is executed after the main injection. Therefore, the timing of fuel discharge can be made earlier than when fuel discharge is started during execution of the after-injection as the sub-injection. As a result, it is possible to lengthen the time between the end of the fuel discharge and the start of the next multistage injection, and also to ensure a longer time to allow for convergence of the fluctuations of the fuel pressure Pr in the high-pressure fuel pipe 34 due to the fuel discharge from the high-pressure fuel pump 40. Therefore, the fuel pressure Pr in the high-pressure fuel pipe 34 can be easily made more stable before the main injection is started in the next multistage injection.

As shown in FIG. 7, when the next multistage injection is executed, the discharge start timing calculation section 112 calculates, as a discharge start timing Ts, a point in time between the injection start timing Fsm and the end timing Fem of the main injection. Accordingly, the pump driving section 115 drives the high-pressure fuel pump 40 at a point in time t722 between when the main injection is started by the injection valve driving section 111 at a point in time t721 and when the main injection is ended at a point in time t723. The target discharge amount calculation section 113 calculates a target discharge amount TPt at the discharge start timing Ts (point in time t722). The target discharge amount TPt is calculated based on a required fuel injection amount Qt for the next multistage injection calculated by the required injection amount calculation section 106 and a fuel pressure difference ΔP between the current fuel pressure Pr and the target fuel pressure Pt.

After energization control is executed at the point in time t722 to start fuel discharge, the pump driving section 115 performs fuel discharge until a point in time t724 when a lift time Ti calculated based on the target discharge amount TPt has elapsed. The point in time t724, at which the fuel discharge is ended, is earlier than a point in time at which the pre-injection in the next multistage injection is started. Thus, in the period from the point in time t721 when the main injection is started to the start of the next main injection, the fuel discharge is started and ended. In this fuel discharge, the target discharge amount TPt of fuel is discharged from the high-pressure fuel pump 40 to the high-pressure fuel pipe 34. In this case, the after-injection in multistage injection is executed within a period during which fuel is discharged from the high-pressure fuel pump 40.

In the present embodiment, fuel discharge is started in the period between the start of the main injection in multistage injection and the start of the main injection in the next multistage injection. Accordingly, in the period between the end of the fuel discharge and the start of the main injection in the next multistage injection, it is possible to ensure a time to allow for convergence of the fluctuations of the fuel pressure Pr in the high-pressure fuel pipe 34 due to the fuel discharge from the high-pressure fuel pump 40. Therefore, the fuel pressure Pr in the high-pressure fuel pipe 34 can be easily made stable before the next multistage injection is started. As a result, variations in the fuel injection amount of the next main injection can be suppressed.

### Third Embodiment

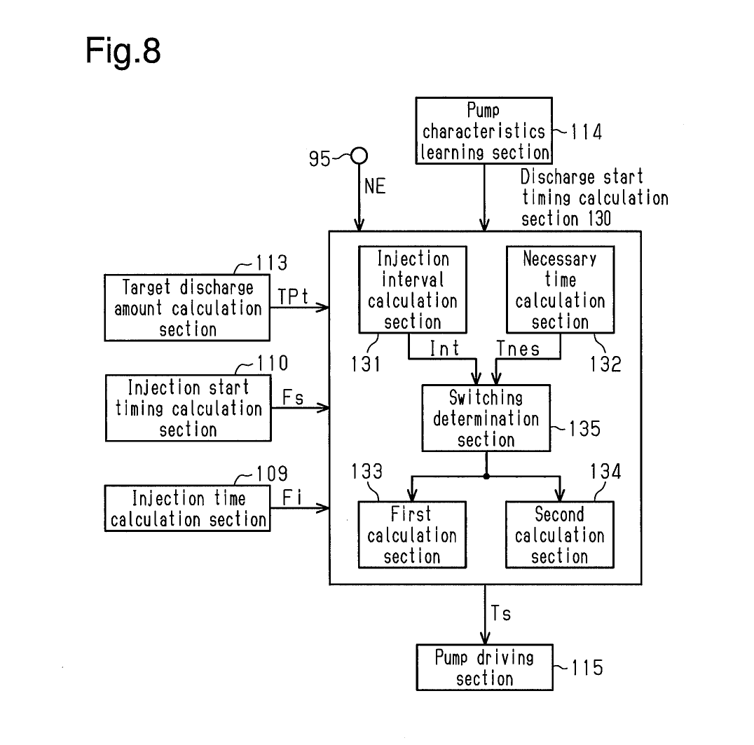

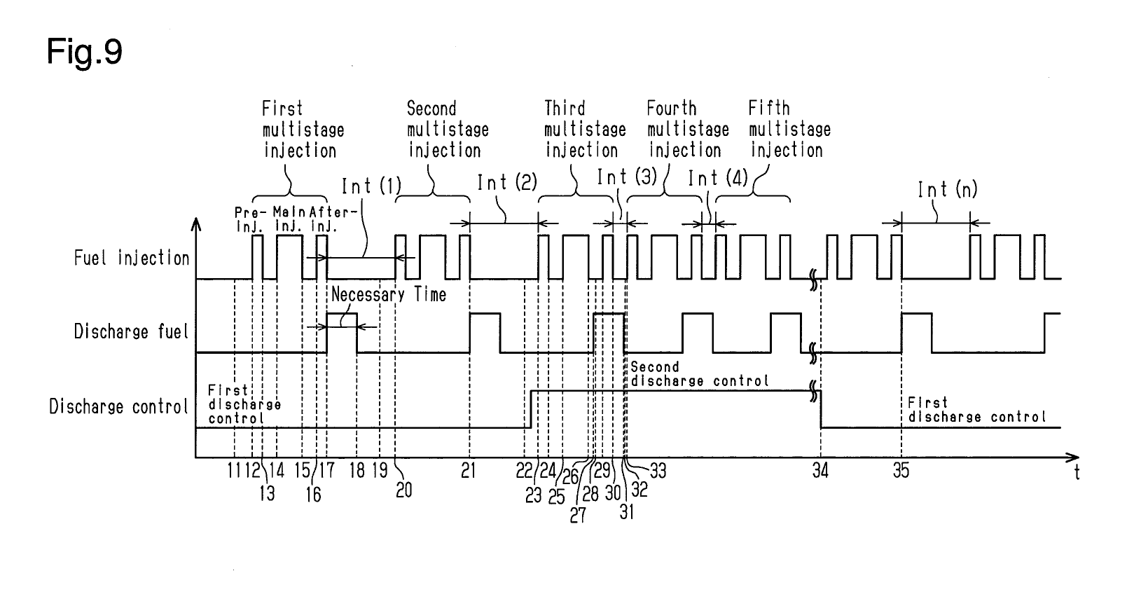

A control device for a fuel pump according to a third embodiment will be described with reference to FIGS. 8 and 9. The third embodiment differs from the above-described embodiments in a manner in which the discharge start timing Ts is set in the discharge start timing calculation section. The same constituent elements as those in the first embodiment are denoted by the same reference numerals, and description thereof is omitted.

As shown in FIG. 8, the discharge start timing calculation section 130 includes an injection interval calculation section 131, a necessary time calculation section 132, a first calculation section 133, a second calculation section 134, and a switching determination section 135 as functional sections.

The injection interval calculation section 131 calculates an injection interval Int of fuel based on the end timing Fe of the multistage injection from the fuel injection valve 15, the injection start timing Fs of the multistage injection calculated by the injection start timing calculation section 110, and the engine rotational speed NE detected by the crank angle sensor 95. In the present embodiment, an injection interval Int of fuel is calculated as a period of time from when the multistage injection is ended at the fuel injection valve 15 provided in any one of the cylinders to when the multistage injection is started at the fuel injection valve 15 provided in the cylinder to be ignited next. For example, in the present embodiment, the first cylinder #1, the third cylinder #3, the fourth cylinder #4, and the second cylinder #2 are ignited in this order. The injection start timing Fs of the multistage injection is equal to the injection start timing of the first injection in the multistage injection, and the end timing Fe of the multistage injection is equal to the injection end timing of the last injection in the multistage injection. The injection start timing Fs of the multistage injection is the same as an injection start timing Fs calculated by the injection start timing calculation section 110 for the first injection in the injection pattern set by the injection pattern setting section 107. The end timing Fe of the multistage injection can be calculated based on an injection time Fi calculated by the injection time calculation section 109 and an injection start timing Fs calculated by the injection start timing calculation section 110 for the last injection in the injection pattern set by the injection pattern setting section 107. The injection interval Int of fuel tends to become shorter as the end timing Fe of the multistage injection is later, the injection start timing Fs of the multistage injection is earlier, or the engine rotational speed NE is higher.

The necessary time calculation section 132 calculates a necessary time Tnes required for the high-pressure fuel pump 40 to discharge fuel of a target discharge amount TPt calculated by the target discharge amount calculation section 113. The necessary time calculation section 132 calculates, as the necessary time Tnes, an energization time required for the high-pressure fuel pump 40 to discharge the target discharge amount TPt of fuel to the high-pressure fuel pipe 34, based on a relationship between the pump characteristics of the high-pressure fuel pump learned by the pump characteristics learning section 114, that is, the energization time for the high-pressure fuel pump 40, and an amount of fuel to be discharged from the high-pressure fuel pump 40 to the high-pressure fuel pipe 34.

The first calculation section 133 calculates a discharge start timing Ts that is a start timing at which fuel discharge from the high-pressure fuel pump 40 to the high-pressure fuel pipe 34 is performed. The discharge start timing Ts is calculated based on the timing of fuel injection from the fuel injection valve 15. In the present embodiment, the first calculation section 133 calculates, as the discharge start timing Ts, the end timing Fe at which the multistage injection from the fuel injection valve 15 is ended. As described above, the end timing Fe of the multistage injection can be calculated based on the injection time Fi of the last injection in the injection pattern set by the injection pattern setting section 107 and the injection start timing Fs of the last injection.

The second calculation section 134 calculates the discharge start timing Ts as a point in time within a period between an end timing Fem of the main injection in the multistage injection and an injection start timing Fss of the sub-injection executed after the main injection. The second calculation section 134 calculates, as the discharge start timing Ts, a point in time closer to the end timing Fem of the main injection than the middle of both the timings Fem and Fss in the period between the end timing Fem of the main injection and the injection start timing Fss of the sub-injection. The end timing Fem of the main injection can be calculated based on the injection time Fim of the main injection calculated by the injection time calculation section 109 and the injection start timing Fsm of the main injection calculated by the injection start timing calculation section 110. The injection start timing Fss of the sub-injection is the same as the injection start timing of the injection to be executed immediately after the main injection, out of the injection start timings calculated by the injection start timing calculation section 110.

The switching determination section 135 switches the calculation section to calculate the discharge start timing Ts to one of the first calculation section 133 and the second calculation section 134, based on the injection interval Int of fuel calculated by the injection interval calculation section 131 and the necessary time Tnes calculated by the necessary time calculation section 132. When the injection interval Int is equal to or longer than the necessary time Tnes (Int Tnes) and the injection interval Int is long, the switching determination section 135 sets the first calculation section 133 as the calculation section to calculate the discharge start timing Ts. Accordingly, if the fuel discharge from the high-pressure fuel pump 40 can be completed within the injection interval Int, the discharge start timing Ts is set to the end timing Fe at which the multistage injection from the fuel injection valve 15 is ended. Further, when the injection interval Int is shorter than the necessary time Tnes (Int<Tnes) and the injection interval Int is short, the switching determination section 135 sets the second calculation section 134 as the calculation section to calculate the discharge start timing Ts. Accordingly, if the fuel injection from the high-pressure fuel pump 40 cannot be completed within the injection interval Int, the discharge start timing Ts is set to a point in time between the end timing Fem of the main injection in the multistage injection and the injection start timing Fss of the sub-injection executed after the main injection.

The pump driving section 115 performs energization control of the high-pressure fuel pump 40 to the coil 85 at the discharge start timing Ts calculated by the discharge start timing calculation section 130. That is, when the switching determination section 135 sets that the discharge start timing Ts is to be calculated by the first calculation section 133, the pump driving section 115 performs the energization control at the discharge start timing Ts calculated by the first calculation section 133. In this case, a first discharge control is executed in which fuel discharge is performed in the period between the end of the multistage injection and the start of the next multistage injection but fuel discharge is not performed in the period during which the multistage injection is performed. The first calculation section 133 and the pump driving section 115 function as a first execution section configured to execute the first discharge control. Further, when the switching determination section 135 sets that the discharge start timing Ts is to be calculated by the second calculation section 134, the pump driving section 115 performs the energization control at the discharge start timing Ts calculated by the second calculation section 134. In this case, a second discharge control is executed in which fuel discharge is started in the period between the end of the main injection and the start of the sub-injection executed after the main injection. The second calculation section 134 and the pump driving section 115 function as a second execution section configured to execute the second discharge control. The discharge control of the high-pressure fuel pump 40 is switched between the first discharge control and the second discharge control by the switching determination section 135.

The pump driving section 115 causes the plunger 75 to reciprocate through the energization control, thereby causing the high-pressure fuel pump 40 to execute fuel suction and fuel discharge. The pump driving section 115 ends the energization when a lift time Ti has elapsed from the start of the energization control for the high-pressure fuel pump 40. The pump driving section 115 sets the lift time Ti such that an amount of fuel corresponding to the target discharge amount TPt is discharged, based on the pump characteristics learned by the pump characteristics learning section 114. The lift time Ti is equal to the necessary time Tnes.

An operation and advantages of the present embodiment will now be described with reference to FIG. 9. In FIG. 9, regarding a symbol t indicating the point in time of each operation and three-digit numbers following the symbol, the symbol t and the first digit 9 of the three digits are omitted. A case where the injection pattern for multistage injection includes the pre-injection, the main injection, and the after-injection will be described below as an example.

In conjunction with the operation of the internal combustion engine 10, multistage injection is repeatedly executed. In the multistage injection, the pre-injection, the main injection, and the after-injection are executed in this order. When this fuel injection is executed, the required injection amount calculation section 106 first calculates a required fuel injection amount Qt before the fuel injection is executed. After that, the multistage injection amount setting section 108 calculates the target injection amount of each injection in the multistage injection based on the required fuel injection amount Qt, and the injection time calculation section 109 calculates the injection time Fi of each injection. In addition, the injection start timing calculation section 110 calculates the injection start timing Fs of each injection in the multistage injection based on the required fuel injection amount Qt.

In the present embodiment, before a first multistage injection executed at a point in time t912, an injection time Fi and an injection start timing Fs of each injection in the first multistage injection are calculated. Further, at a point in time t911 that is a little earlier than the point in time t912, at which the first multistage injection is started, an injection time Fi and an injection start timing Fs of each injection in a second multistage injection to be executed after the first multistage injection are calculated. In the period between when the injection time Fi and the injection start timing Fs of each injection in the second multistage injection are calculated and when the first multistage injection is started (point in time t911 to point in time t912), a discharge start timing Ts at which fuel discharge from the high-pressure fuel pump 40 to the high-pressure fuel pipe 34 is started is calculated. That is, when the injection time Fi and the injection start timing Fs of each injection in the second multistage injection are calculated at the point in time t911, the injection interval calculation section 131 calculates an injection interval Int(1) of fuel for the multistage injection based on the injection time Fi and the injection start timing Fs. The injection interval Int(1) of fuel is an interval between the end timing (t917) of the first multistage injection and the start timing (t920) of the second multistage injection.

Further, when a required fuel injection amount Qt for the first multistage injection is calculated by the required injection amount calculation section 106, the target discharge amount calculation section 113 calculates a target discharge amount TPt based on the required fuel injection amount Qt and a fuel pressure difference ΔP between the current fuel pressure Pr and the target fuel pressure Pt. That is, the target discharge amount TPt is calculated before the point in time at which the discharge start timing Ts is calculated. The necessary time calculation section 132 calculates a necessary time Tnes required for the high-pressure fuel pump 40 to discharge fuel of a target discharge amount TPt calculated by the target discharge amount calculation section 113. In this way, when the injection interval Int(1) is calculated at the point in time t911 after the necessary time Tnes is calculated, the switching determination section 135 determines which one of the first calculation section 133 and the second calculation section 134 is used to calculate the discharge start timing Ts. In the example shown in FIG. 9, the injection interval Int(1) between the first multistage injection and the second multistage injection is longer than the necessary time Tnes. Accordingly, in the period between the point in time t911 and the point in time t912, the switching determination section 135 sets that the discharge start timing Ts is to be calculated by the first calculation section 133. Even before the point in time t911, the switching determination section 135 sets that the discharge start timing Ts is to be calculated by the first calculation section 133. Accordingly, the discharge control of the high-pressure fuel pump 40 is set to the first discharge control before the first multistage injection is executed.

After that, the injection valve driving section 111 starts fuel injection at a point in time t912 that is an injection start timing Fsp of the pre-injection in the first multistage injection calculated by the injection start timing calculation section 110. Thus, the first multistage injection is started. The injection valve driving section 111 continues the fuel injection during an injection time Fip of the pre-injection in the first multistage injection calculated by the injection time calculation section 109, and ends the pre-injection at a point in time t913 when the injection time Fip of the pre-injection has elapsed from the point in time t912. After that, the injection valve driving section 111 starts fuel injection at a point in time t914 that is an injection start timing Fsm of the main injection in the first multistage injection calculated by the injection start timing calculation section 110. The injection valve driving section 111 continues the fuel injection during an injection time Fim of the main injection in the first multistage injection calculated by the injection time calculation section 109, and ends the main injection at a point in time t915 when the injection time Fim of the main injection has elapsed from the point in time t914. After that, the injection valve driving section 111 starts fuel injection at a point in time t916 that is an injection start timing Fsa of the after-injection in the first multistage injection calculated by the injection start timing calculation section 110. The injection valve driving section 111 continues the fuel injection during an injection time Fia of the after-injection in the first multistage injection calculated by the injection time calculation section 109, and ends the after-injection at a point in time t917 when the injection time Fia of the after-injection has elapsed from the point in time t916. Thus, the first multistage injection is ended. In this way, the first multistage injection from the fuel injection valve 15 is executed.

The first calculation section 133 sets the discharge start timing Ts to the same point in time as the end timing Fe at which the first multistage discharge is ended. Accordingly, at the point in time t917 when the first multistage discharge is ended, the pump driving section 115 starts energization control to discharge the calculated target discharge amount TPt of fuel, and drives the high-pressure fuel pump 40. The fuel discharge is executed during the period between the point in time t917 and a point in time t918 when the lift time Ti has elapsed. As a result, the target discharge amount TPt of fuel is discharged from the high-pressure fuel pump 40.

After that fuel discharge is performed, at a point in time t919 earlier than the injection start timing Fs of the second multistage injection (point in time t920), an injection time Fi and an injection start timing Fs of each injection in a third multistage injection to be executed after the second multistage injection are calculated. Then, in the period between the point in time t919 and the injection start timing Fs of the second multistage injection, the switching determination section 135 determines which one of the first calculation section 133 and the second calculation section 134 is used to calculate the discharge start timing Ts based on an injection interval Int(2) between the second multistage injection and the third multistage injection. In the example shown in FIG. 9, since the injection interval Int(2) between the second multistage injection and the third multistage injection is longer than the necessary time Tnes, the switching determination section 135 sets that the discharge start timing Ts is to be calculated by the first calculation section 133. Thus, the first discharge control is continued.

After that, the injection valve driving section 111 starts fuel injection at the point in time t920 that is an injection start timing Fsp of the pre-injection in the second multistage injection calculated by the injection start timing calculation section 110. Thus, the second multistage injection is started. When the pre-injection is ended, the injection valve driving section 111 sequentially executes the main injection and the after-injection. The injection valve driving section 111 ends the after-injection at a point in time t921. Thus, the second multistage injection is ended. After the second multistage injection is executed, at the point in time t921 when the second multistage discharge is ended, the pump driving section 115 starts energization control to discharge the target discharge amount TPt of fuel, and drives the high-pressure fuel pump 40.

When the operating state of the internal combustion engine 10 changes and the rotational speed of the internal combustion engine thus increases, the injection interval Int decreases. In the example shown in FIG. 9, an injection interval Int(3) between the third multistage injection and a fourth multistage injection to be executed after the third multistage injection is short. In this case, first, an injection time Fi and an injection start timing Fs of each injection in the fourth multistage injection are calculated at a point in time t922 after the fuel discharge is ended at the point in time t921 and before the third multistage injection is started. Then, in the period between the point in time t921 and the injection start timing Fs (point in time t923) of the third multistage injection, the switching determination section 135 determines which one of the first calculation section 133 and the second calculation section 134 is used to calculate the discharge start timing Ts based on an injection interval Int(3) between the third multistage injection and the following fourth multistage injection. In the example shown in FIG. 9, the injection interval Int(3) between the third multistage injection and the fourth multistage injection is shorter than the necessary time Tnes. For this reason, the switching determination section 135 sets that the discharge start timing Ts is to be calculated by the second calculation section 134. Thus, the discharge control of the high-pressure fuel pump 40 is switched from the first discharge control to the second discharge control in the period between the point in time t922 and the point in time t923.

The injection valve driving section 111 starts fuel injection at the point in time t923 that is an injection start timing Fsp of the pre-injection in the third multistage injection calculated by the injection start timing calculation section 110. Thus, the third multistage injection is started. The injection valve driving section 111 continues the fuel injection during an injection time Fip of the pre-injection in the third multistage injection calculated by the injection time calculation section 109, and ends the pre-injection at a point in time t924 when the injection time Fip of the pre-injection has elapsed from the point in time t923. After that, the injection valve driving section 111 starts fuel injection at a point in time t925 that is an injection start timing Fsm of the main injection in the third multistage injection calculated by the injection start timing calculation section 110. The injection valve driving section 111 continues the fuel injection during an injection time Fim of the main injection in the third multistage injection calculated by the injection time calculation section 109, and ends the main injection at a point in time t926 when the injection time Fim of the main injection has elapsed from the point in time t925.

The second calculation section 134 sets the discharge start timing Ts to a point in time between the end timing Fem of the main injection and the injection start timing Fsa of the after-injection. Accordingly, the pump driving section 115 drives the high-pressure fuel pump 40 at a point in time t927 between when the main injection is ended at the point in time t926 and when the after-injection is started by the injection valve driving section 111. The discharge start timing Ts is calculated as the point in time t927 closer to the end timing Fem (point in time t926) of the main injection than a point in time t928 that is the middle of both the timings Fem and Fsa in the period between the end timing Fem (point in time t926) of the main injection and the injection start timing Fsa (point in time t929) of the after-injection. After energization control is executed at the point in time t927 to start fuel discharge, the pump driving section 115 performs fuel discharge until a point in time t931 when a lift time Ti calculated based on the target discharge amount TPt has elapsed. As a result, the target discharge amount TPt of fuel is discharged from the high-pressure fuel pump 40.

Further, after the fuel discharge is started by the pump driving section 115, the injection valve driving section 111 starts the after-injection at the injection start timing Fsa (point in time t929) of the after-injection in the third multistage injection calculated by the injection start timing calculation section 110. The injection time Fia of the after-injection in the third multistage injection is shorter than the lift time Ti described above, and the after-injection is ended at a point in time (t930) earlier than the end point in time t931 of fuel discharge. Accordingly, the after-injection in the third multistage injection is executed within a period during which fuel is discharged from the high-pressure fuel pump 40. Executing the after-injection in this way, the third multistage injection is ended.

After that third multistage injection and the fuel discharge are performed, at the following point in time t932, an injection time Fi and an injection start timing Fs of each injection in a fifth multistage injection to be executed after the fourth multistage injection are calculated. Then, in the period between the point in time t932 and the injection start timing Fs (point in time t933) of the fourth multistage injection, the switching determination section 135 sets which one of the first calculation section 133 and the second calculation section 134 is used to calculate the discharge start timing Ts based on an injection interval Int(4) between the fourth multistage injection and the fifth multistage injection. In the example shown in FIG. 9, since the injection interval Int(4) between the fourth multistage injection and the fifth multistage injection is shorter than the necessary time Tnes, the switching determination section 135 sets that the discharge start timing Ts is to be calculated by the second calculation section 134. Thus, the second discharge control is continued.

After that, if the operating state of the internal combustion engine 10 changes and the rotational speed of the internal combustion engine thus decreases, the injection interval Int(n) between the end timing of the multistage injection and the start timing of the next multistage injection becomes longer than the necessary time Tnes required for discharging fuel. In this case, at a point in time t934 before a multistage injection is started, the switching determination section 135 sets that the discharge start timing Ts is to be calculated by the first calculation section 133. Accordingly, the discharge control of the high-pressure fuel pump 40 is switched from the second discharge control to the first discharge control. As a result, fuel discharge is performed at a point in time t935, at which the multistage injection is ended.

In the present embodiment, when the injection interval Int between the end timing Fe of the multistage injection and the injection start timing Fs of the next multistage injection is equal to or longer than the necessary time Tnes required for discharging fuel, the first discharge control is executed. Specifically, fuel discharge is performed in the period between the end of the multistage injection and the start of the next multistage injection but fuel discharge is not performed in the period during which the multistage injection is performed. In other words, if the injection interval Int is long and the fuel discharge can be completed within the injection interval Int, the fuel discharge is started within the injection interval Int, and fuel discharge is not performed in the injection period during which the fuel injection is executed. Therefore, when the fuel injection is executed, the fluctuations of the fuel pressure Pr in the high-pressure fuel pipe 34 due to the fuel discharge from the high-pressure fuel pump 40 can be suppressed.

Further, when the injection interval Int is less than the necessary time Tnes, the second discharge control for starting the fuel discharge is executed in the period between the end of the main injection and the start of the after-injection to be executed after the main injection. In other words, if the injection interval Int is short and the fuel injection cannot be completed within the injection interval Int, the fuel discharge is performed at time avoiding the main injection which most contributes to combustion but at time as close to the main injection as possible after the main injection. That fuel discharge from the high-pressure fuel pump 40 performed while avoiding the injection period of the main injection makes it possible to suppress the fluctuations of the fuel pressure Pr in the high-pressure fuel pipe 34 during execution of the main injection and thus to ensure a combustion quality. In addition, earlier start of fuel discharge than the start of fuel discharge during execution of the after-injection makes it possible to lengthen the time from the completion of fuel discharge to the start of the next multistage injection, and also to ensure a longer time to allow for convergence of the fluctuations of the fuel pressure Pr in the high-pressure fuel pipe 34 due to the fuel discharge from the high-pressure fuel pump 40. Thus, the fuel pressure Pr in the high-pressure fuel pipe 34 can be easily made more stable before the main injection is started in the next multistage injection. Therefore, fuel can be supplied to the high-pressure fuel pipe 34 at the point in time that makes it possible to suppress the fluctuations of the fuel pressure Pr during the injection period of the fuel injection.

The above-described embodiments may be modified as follows. The above-described embodiments and the following modifications can be combined as long as the combined modifications remain technically consistent with each other.

In the first embodiment, the discharge start timing calculation section 112 calculates a point in time at which the predetermined preparation time has elapsed from the end timing Fe of the multistage injection as the discharge start timing Ts. Calculation of the discharge start timing Ts can be changed as appropriate. For example, the same point in time as the end timing Fe of the multistage injection may be calculated as the discharge start timing Ts, without taking into consideration the preparation time. In this case, the fuel discharge is started at the point in time at which the multistage injection is ended.

In the first embodiment, the injection pattern for multistage injection including the pre-injection, the main injection, and the after-injection is exemplified, but the injection pattern for multistage injection is not limited thereto. For example, as the injection pattern for multistage injection, an injection pattern including the pre-injection and the main injection but not including the after-injection may be employed. In this case, the discharge start timing Ts is set between the end timing of the main injection in the current multistage injection and the start timing of the pre-injection in the next multistage injection. Further, as the injection pattern for multistage injection, an injection pattern including the main injection and the after-injection but not including the pre-injection can be employed. In this case, the discharge start timing Ts is set between the end timing of the after-injection in the current multistage injection and the start timing of the main injection in the next multistage injection. In addition, as the injection pattern for multistage injection, an injection pattern including the pilot-injection or the post-injection can be employed.

In the second embodiment, the discharge start timing calculation section 112 calculates, as the discharge start timing Ts, a point in time closer to the end timing Fem of the main injection than the middle of both the timings Fem and Fsa in the period between the end timing Fem of the main injection and the injection start timing Fsa of the after-injection. Instead of this configuration, the discharge start timing calculation section 112 may calculate, as the discharge start timing Ts, the midpoint of both the timings Fem and Fsa in the period between the end timing Fem of the main injection and the injection start timing Fsa of the after-injection. In addition, the discharge start timing calculation section 112 may calculate, as the discharge start timing Ts, a point in time closer to the injection start timing Fsa of the after-injection than the middle of both the timings Fem and Fsa in the above period. Further, the discharge start timing Ts may be the same point in time as the end timing Fem of the main injection. In this case, the fuel discharge is started immediately after the main injection is ended.

In the second embodiment, the injection pattern for multistage injection including the pre-injection, the main injection, and the after-injection is exemplified, but the injection pattern for multistage injection is not limited thereto. For example, as the injection pattern for multistage injection, an injection pattern including the main injection and the after-injection but not including the pre-injection can be employed. Further, as the injection pattern for multistage injection, an injection pattern including the main injection and the post-injection but not including the after-injection can be employed. In this case, it is possible to provide a configuration in which the fuel discharge is started in the period between the end of the main injection and the start of the post-injection.

In the second embodiment, the discharge start timing calculation section 112 is configured to set the discharge start timing Ts to a point in time between the end timing Fem of the main injection and the discharge start timing Fsa of the after-injection, or a point in time between the discharge start timing Fsm and the end timing Fem of the main injection. The discharge timing of fuel is not limited to this. For example, the discharge start timing Ts can be set to a point in time in the period during which the sub-injection to be executed after the main injection is executed. Since the fuel discharge is started during execution of the sub-injection, this configuration can make the discharge start timing Ts earlier than the configuration in which the fuel discharge is started after the end of the sub-injection. Further, the discharge start timing Ts can be set to a point in time after the end of the main injection and the after-injection and before the injection start timing Fsp of the pre-injection of the next multistage injection. In this configuration, it is possible to execute fuel discharge so that it overlaps with only the pre-injection injection period among the main injection, the pre-injection, and the after-injection.

In the third embodiment, the first calculation section 133 calculates, as the discharge start timing Ts, the end timing Fe at which the multistage injection from the fuel injection valve 15 is ended, but calculation of the discharge start timing Ts is not limited thereto. For example, the first calculation section 133 can calculate, as the discharge start timing Ts, a point in time when the preparation time has elapsed from the end timing Fe at which the multistage injection from the fuel injection valve 15 is ended.

In the third embodiment, the second calculation section 134 calculates, as the discharge start timing Ts, a point in time closer to the end timing Fem of the main injection than the middle of both the timings Fem and Fsa in the period between the end timing Fem of the main injection and the injection start timing Fsa of the after-injection. Instead of this configuration, the second calculation section 134 may calculate, as the discharge start timing Ts, the midpoint of both the timings Fem and Fsa in the period between the end timing Fem of the main injection and the injection start timing Fsa of the after-injection. In addition, the second calculation section 134 may calculate, as the discharge start timing Ts, a point in time closer to the injection start timing Fsa of the after-injection than the middle of both the timings Fem and Fsa in the above period. Further, the discharge start timing Ts may be the same point in time as the end timing Fem of the main injection. In this case, the fuel discharge is started immediately after the main injection is ended.

In the third embodiment, the injection pattern for multistage injection including the pre-injection, the main injection, and the after-injection is exemplified, but the injection pattern for multistage injection is not limited thereto. For example, as the injection pattern for multistage injection, an injection pattern including the main injection and the after-injection but not including the pre-injection can be employed. Further, as the injection pattern for multistage injection, an injection pattern including the main injection and the post-injection but not including the after-injection can be employed. In this case, the second calculation section 134 may start fuel discharge in the period between the end of the main injection and the start of the post-injection.

In the third embodiment, the second calculation section 134 is configured to set the discharge start timing Ts to a point in time between the end timing Fem of the main injection and the injection start timing Fsa of the after-injection. The discharge timing of fuel is not limited to this. For example, the discharge start timing Ts can be set to a point in time between the start and the end of the main injection, a point in time in the period during which the sub-injection to be executed after the main injection is executed, etc. That is, for example, if the injection pattern for multistage injection includes the main injection, the after-injection, and the post-injection, the second calculation section 134 can set the discharge start timing Ts to a point in time in the period during which the main injection is executed, a point in time between the end timing Fem of the main injection and the injection start timing Fsa of the after-injection, a point in time in the period during which the after-injection is executed, a point in time between the end timing Fea of the after-injection and the injection start timing of the post-injection, or a point in time in the period during which the post-injection is executed. In order to lengthen the time between the completion of the fuel discharge from the high-pressure fuel pump 40 and the start of the next multistage injection, it is desirable to calculate a point in time close to the end timing Fem of the main injection as the discharge start timing Ts. In these configurations, since the fuel discharge is started during execution of the sub-injection, the discharge start timing Ts can be made earlier than that in the configuration in which the fuel discharge is started after the end of the sub-injection.

In the third embodiment, the fuel discharge is executed so that it overlaps with only the injection period of the after-injection. However, the fuel discharge may be executed in a period overlapping with both the injection period of the after-injection and the injection period of the following pre-injection.

In the third embodiment, if the injection interval Int is equal to or longer than the necessary time Tnes (Int Tnes) and the injection interval Int is long, the switching determination section 135 executes the first discharge control; if the injection interval Int is shorter than the necessary time Tnes (Int<Tnes) and the injection interval Int is short, the switching determination section 135 executes the second discharge control. Switching of the discharge control in the switching determination section 135 is not limited to this. For example, even if the injection interval Int is shorter than the necessary time Tnes (Int<Tnes), the switching determination section 135 may determine that the injection interval Int is long and execute the first discharge control when the difference between the injection interval Int and the necessary time Tnes is relatively small. In this case, when the injection interval Int is shorter than the necessary time Tnes and the difference between the injection interval Int and the necessary time Tnes becomes relatively large, the switching determination section 135 can determine that the injection interval Int is short and execute the second discharge control. That is, a determination value for the switching determination section 135 to determine the switching of the discharge control is not limited to the necessary time Tnes. As the determination value, a value smaller or larger than the necessary time Tnes can be used.

The fuel in the fuel tank 31 may be drawn in by the high-pressure fuel pump 40. In this case, the low-pressure fuel pump 32 and the low-pressure fuel pipe 33 can be omitted.

The configuration of the high-pressure fuel pump 40 can be changed as appropriate. For example, the plunger 75 may be composed of a round bar portion that is made of a material different from magnetic material and is inserted in the cylinder bore 57, and a magnetic portion that is connected to one end of the round bar portion and is made of a magnetic material. Furthermore, a configuration may be provided in which the plunger 75 is displaced by moving the magnetic portion by a magnetic field generated by energizing the coil 85 so that the volume of the pressurizing chamber 78 is changed. In other words, as long as the fuel pump can reciprocate the plunger 75 by energization and has a suction function of drawing in fuel by reciprocating the plunger 75 and a discharge function of pressurizing and discharging the drawn fuel, the same control device as that in each of the above-described embodiments can be adapted for the fuel pump.

The control device 100 for a fuel pump has a function of controlling driving of the fuel injection valve 15. This function may be included in a control section different from the control device 100 for the fuel pump. In this case, the control device 100 may be configured to communicate with the control section to transmit and receive necessary information to and from each other so that the driving of the fuel pump is controlled in the same manner as in each of the above-described embodiments.

The control device is not limited to a device that includes a CPU, a ROM, and a RAM and executes software processing. For example, a dedicated hardware circuit (such as an ASIC) may be provided that executes at least part of the software processes executed in each of the above-described embodiments. That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

1. A control device for a fuel pump, the fuel pump being a motor-driven fuel pump adapted for an internal combustion engine, the internal combustion engine including a fuel injection valve configured to execute multistage injection in which fuel is injected into a cylinder multiple times in one combustion cycle, the fuel pump being configured to supply fuel to a fuel pipe connected to the fuel injection valve, wherein
the fuel pump includes a cylinder, a mover configured to slide in the cylinder, and an electric actuator configured to move the mover, and
the control device comprises processing circuitry that is configured to
perform energization control on the electric actuator to reciprocate the mover so that the fuel pump draws in fuel and discharges fuel, and
cause the fuel pump to discharge fuel in a period between an end of a multistage injection from the fuel injection valve and a start of a next multistage injection, and keep the fuel pump from discharging fuel in a period during which the multistage injection from the fuel injection valve is executed.

2. A control device for a fuel pump, the fuel pump being a motor-driven fuel pump adapted for an internal combustion engine, the internal combustion engine including a fuel injection valve configured to execute multistage injection in which fuel is injected into a cylinder multiple times in one combustion cycle, the multistage injection including main injection in which the largest amount of fuel is injected and sub-injection in which a smaller amount of fuel than the amount in the main injection is injected, the fuel pump being configured to supply fuel to a fuel pipe connected to the fuel injection valve, wherein
the fuel pump includes a cylinder, a mover configured to slide in the cylinder, and an electric actuator configured to move the mover, and
the control device comprises processing circuitry that is configured to
perform energization control on the electric actuator to reciprocate the mover so that the fuel pump draws in and discharges fuel, and
cause the fuel pump to start fuel discharge and end the fuel discharge in a period between a start or an end of the main injection and a start of a next main injection.

3. The control device for a fuel pump according to claim 2, wherein the processing circuitry is configured to cause the fuel pump to start fuel discharge in a period between an end of the main injection and a start of the sub-injection that is executed after the main injection.

4. The control device for a fuel pump according to claim 2, wherein the processing circuitry is configured to cause the fuel pump to start fuel discharge in a period during which the sub-injection that is executed after the main injection is executed.

5. The control device for a fuel pump according to claim 2, wherein
the sub-injection includes pre-injection in which fuel is injected before the main injection and after-injection in which fuel is injected after the main injection, and
the processing circuitry is configured to cause the fuel pump to execute fuel discharge only in a period during which one of the pre-injection and the after-injection is executed.

6. The control device for a fuel pump according to claim 5, wherein the processing circuitry is configured to cause the fuel pump to execute fuel discharge only in a period during which the after-injection is executed.

7. A control device for a fuel pump, the fuel pump being a motor-driven fuel pump adapted for an internal combustion engine, the internal combustion engine including a fuel injection valve configured to execute multistage injection in which fuel is injected into a cylinder multiple times in one combustion cycle, the multistage injection including main injection in which the largest amount of fuel is injected and sub-injection in which a smaller amount of fuel than the amount in the main injection is injected, the fuel pump being configured to supply fuel to a fuel pipe connected to the fuel injection valve, wherein
the fuel pump includes a cylinder, a mover configured to slide in the cylinder, and an electric actuator configured to move the mover, and
the control device comprises processing circuitry that is configured to
perform energization control on the electric actuator to reciprocate the mover so that the fuel pump draws in and discharges fuel,
execute a first discharge control, in which, when an injection interval between an end timing of the multistage injection from the fuel injection valve and a start timing of the next multistage injection is equal to or larger than a determination value, the processing circuitry causes the fuel pump to start fuel discharge in a period between an end of the multistage injection and a start of the next multistage injection, and keep the fuel pump from executing fuel discharge in a period during which the multistage injection from the fuel injection valve is executed, and
execute a second discharge control, in which, when the injection interval is less than the determination value, the processing circuitry causes the fuel pump to start fuel discharge in a period between an end of the main injection and a start of the sub-injection that is executed after the main injection.
